(19) United States
(12) Patent Application Publication
(10) Pub. No.: US 2008/0019281 A1
(43) Pub. Date: Jan. 24, 2008

(54) Reuse of available source data and localizations

(75) Inventors: Francois M. Liger, Redmond, WA (US); Jordi Mola Marti, Redmond, WA (US); Bernhard Kohlmeier, Woodinville, WA (US); Refaat Issa, Sammamish, WA (US); Mohamed K. Elgazzar, Redmond, WA (US); Cameron B. Lerum, Renton, WA (US); Jason Kepner, Snoqualmie, WA (US); Viraj Mody, Bellevue, WA (US); Jan Nelson, Gig Harbor, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Microsoft Corporation, Redmond, WA (US)

(21) Appl. No.: 11/490,563

(22) Filed: Jul. 21, 2006

(51) Int. Cl. H04J 1/16

(52) U.S. Cl. 370/252

(57) ABSTRACT

Generally described, aspects of the present invention are directed toward providing available source data and localized information to a user. More specifically, a source string is obtained and used to retrieve a corresponding set of available source data. The source data can include available resources or available content. Further, the resources can correspond to strings. An element from the set of available source data can be selected and used to obtain data associated with the selected element. The associated data can include localized information corresponding to the selection of source data. Thus, available source data and corresponding localized information can be obtained and used in an application or document.

### BACKGROUND

During development of an application for computer systems, an author may create a resource which is similar to one or more available resources. Furthermore, the one or more available resources may have been through a validation process to ensure that the available resources conform to certain requirements. Additionally, the available resources may have been localized for use in applications on various platforms across various markets. Currently, there is no easy and efficient way to access the available resources, or any corresponding localizations, for reuse in a new application.

An example of where resource reuse can add value is during the development of an application that processes information. For example, the application may display information to a user interface. During the development process, an author, who may also be the application developer, may create a string that will be used in the user interface of the application. This string may be similar, but not exactly identical, to one or more available strings. The available strings may have been through a validation process to ensure that they conform to certain requirements. For example, the available strings may have been validated to ensure that they are grammatically correct and that consistent terminology is used. If the author of the new string had access to the available strings, the author could choose to reuse one of the available strings as opposed to creating a new string which may negatively affect the user experience. For example, a newly created string may use complex or ambiguous language, may have formatting or style issues, may use inconsistent terminology, may introduce errors, or may cause other problems.

Continuing with the above example, the available strings may also have been localized for use in applications on various platforms or across various markets. Furthermore, the available strings may be localized in the future. The localizations may have also been through various validation processes. For example, an available string may have been previously translated into one or more languages. The translations may have been validated to ensure grammatical correctness, terminology consistency, functional correctness, and the like. Currently, there is no easy and efficient way to access available strings or their corresponding localizations.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In accordance with one aspect, a method for processing data is provided. A request for available source data corresponding to a source string in any language can be obtained. In response to the request, a consolidated set of available source data and corresponding linking data is provided. The linking data links elements within the consolidated set such that updates to any one element propagate to all selections of the element.

In accordance with another aspect, a method for displaying data corresponding to a source string can be provided. The method can be performed in a computer system including a display and an input device. A set of available resources corresponding to the source string can be obtained. The set of available resources can be displayed. A selection of an available resource can be obtained. An associated data set can be obtained. Each element in the associated data set can correspond to a localized version of the selected resource. The associated data set can be displayed or persisted.

In accordance with another aspect, a computer-readable medium having computer-executable components for processing data is provided. A data-processing component and a data-provider interface component can be included in the computer-executable components. The data-processing component can obtain a source string and source data. One or more resources corresponding to the source string can be included in the source data. The data-provider interface component can submit a request for associated data corresponding to a selection of source data and obtain the associated data. The associated data can include localized information corresponding to the selection of source data.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram of an illustrative operating environment including a number of data providers, a data manager, and a client device in accordance with an aspect of the present invention;

FIG. 2A is a block diagram of the operating environment of FIG. 1 illustrating a client device request for matching source data from a data manager and a data provider in accordance with an aspect of the present invention;

FIG. 2B is a block diagram of the operating environment of FIG. 1 illustrating a client device request for associated data from a data manager and a data provider in accordance with an aspect of the present invention;

FIG. 3 is a flow diagram illustrating a data selection and display routine implemented by a client device in accordance with an aspect of the present invention;

FIG. 4 is a block diagram of a user interface including a source string display portion for displaying a source string and a source data display portion for displaying corresponding source data in accordance with an aspect of the present invention; and

FIG. 5 is a block diagram of the user interface of FIG. 4 including an associated data set display portion for displaying an associated data set and a metadata display portion for displaying metadata in accordance with an aspect of the present invention.

### DETAILED DESCRIPTION

Generally described, aspects of the present invention are directed toward providing available source data and localized information for utilization in applications or documents. Applications can include software applications, multimedia applications, Internet applications such as a Web browser, scripts, Web pages, libraries, word processing programs, applications used on portable devices, or any type of application which processes data. More specifically, a source string is obtained and used to search for corresponding source data. The source data can include one or more available resources or one or more content elements. Further, the resources can correspond to strings. For example, the source string can be a string processed by an application and the source data can correspond to strings which have been or will be used in other applications. The resources can also correspond to linking information. For example, an author can link to a resource which has not yet been finalized. One of the resources or content elements included in the source data can be selected to obtain data associated with the selected resource. The associated data can include localized information corresponding to the selection of source data. For example, the associated data can include translations corresponding to the selection of source data. Thus, a user can be provided with available source data and localized information which can be used in an application or document.

Validation processes can be performed on the source string. For example, the source string can be validated as it is entered by a user. Validation processes can also be performed on the source data and the associated data. For example, source data and associated data may be validated before it is used in a new application. Several different types of validation processes can be performed on the source string, source data, and associated data. Examples of the types of validation processes which can be performed include functional validation, linguistic validation, validation according to a black-list or white-list, stylistic validation, terminology validation, and any other type of validation which helps to ensure that data conforms to the validation procedures. The various types of validation processes are described in more detail below.

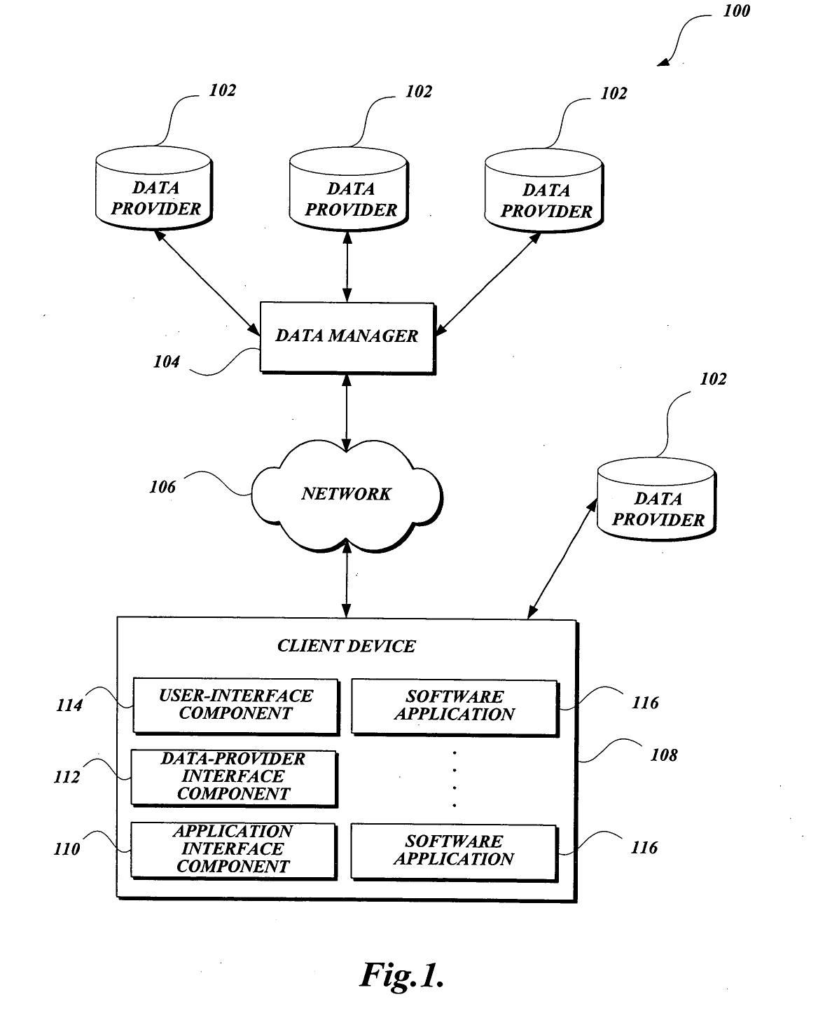

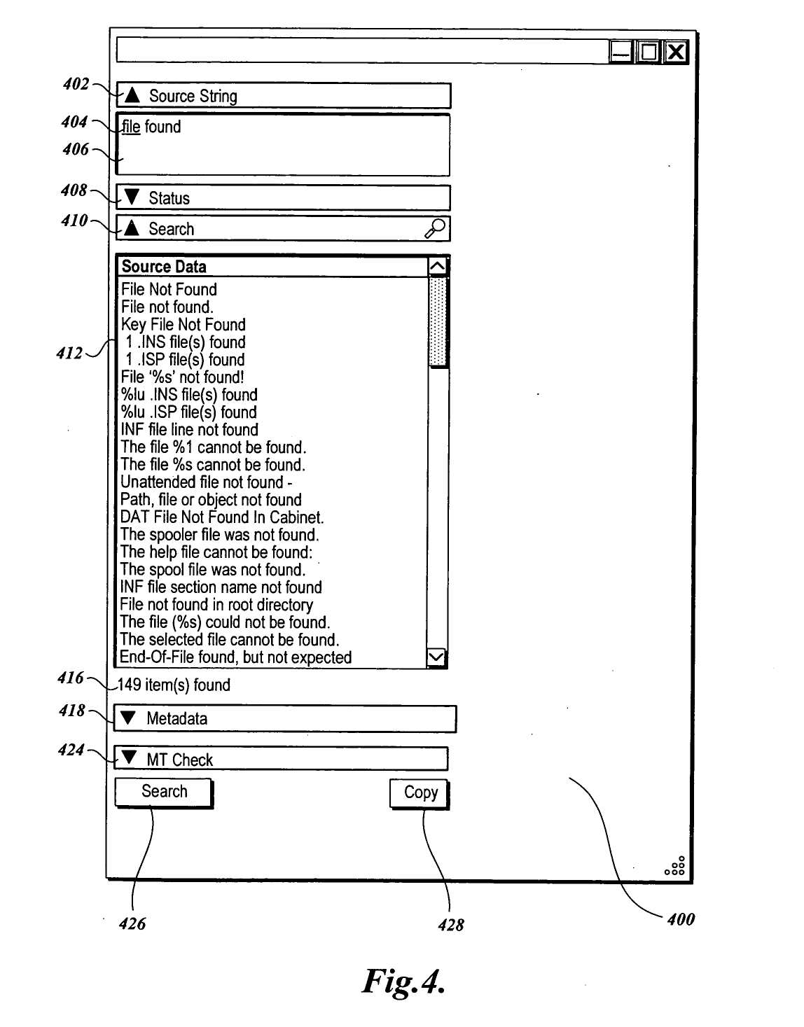

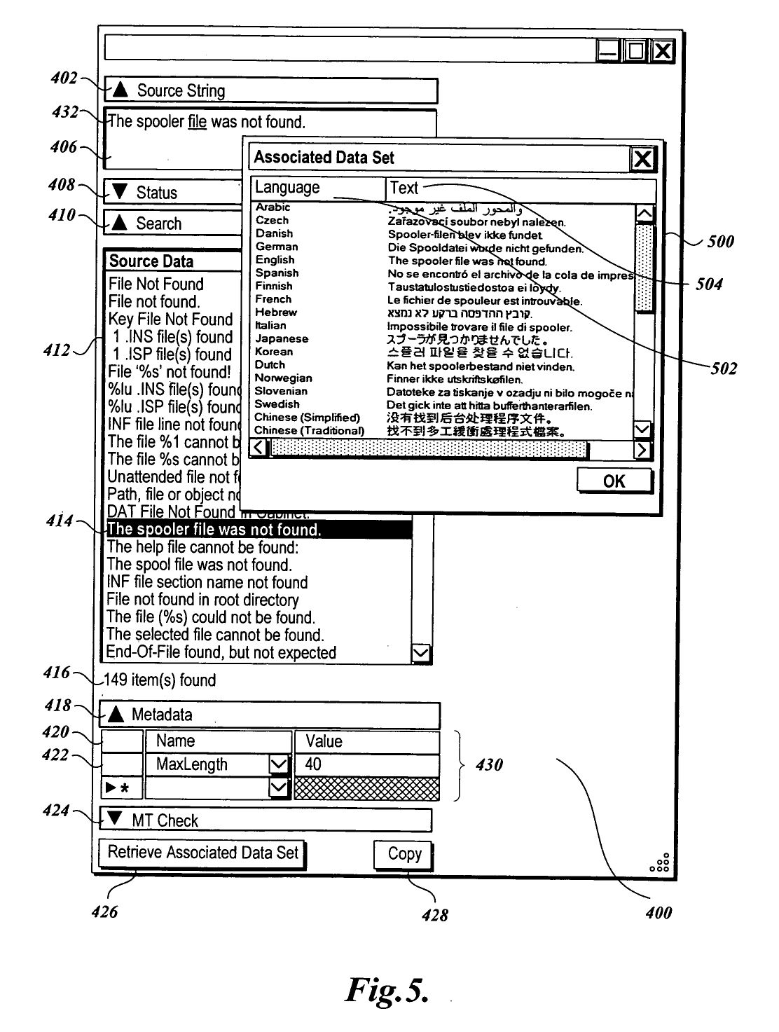

With reference now to FIG. 1, an illustrative operating environment 100 can include a data manager 104 for retrieving and consolidating data from one or more data providers 102 and a client device 108 to facilitate user interaction. The one or more data providers 102 can provide information to a data manager 104. Each data provider 102 can provide source data and/or data associated with the source data. The contents of the source data and associated data sets will be described in more detail below in relation to FIGS. 4 and 5.

A data provider 102 can store and provide data from a third-party data provider, from a machine-translation engine, and/or from data providers designated by a system administrator. A data manager can obtain data from the one or more data providers and consolidate the various data sets. Consolidation of data can involve prioritizing data such that it is displayed to the user or persisted in a certain order. For example, the data manager 104 can learn from user feedback, either explicit or implicit, how to prioritize the results. If a user consistently discards items from a certain data provider, the data can be consolidated such that the items retrieved from that data provider are ranked lower on the data stack over time. There are no inherent restrictions on the data sources. However, a user of the system may choose to limit and/or prioritize the sources of data. For example, a user may choose to exclude third-party data providers or to display or persist data from third-party providers last. Alternatively, the data manager 104 can use other methods to sort the data within the consolidated data set such that data is displayed or persisted in an order relative to the priority of the data. The one or more data providers 102 can provide information directly to the client device 102. In the case where multiple data providers 102 provide information directly to the client device 108, a data manager component 104 located on the client device 108 can consolidate the data sets received from each data provider 102. For example, the data sets can be consolidated such that redundant data is removed from the consolidated set of data. Further, within the consolidated data set, the data can be sorted and displayed in different ways showing higher priority data first.

In an illustrative embodiment, a data-provider interface component 112 can obtain data from one or more data providers 102. The data provider interface component 112 can obtain data from one or more local data providers 102 or from one or more remote data providers 102 over a network 105. A local data provider 102 can be distributed via CD, USB device, or other type of removable storage device. Local data providers 102 can be used in markets where there is insufficient communication structure to use remote data providers 102. Data from the data providers can be consolidated by a data manager component 104 before being provided to the data-provider interface component 112. Locally retrieved data can be consolidated by a data manager component local to the client device 108. The one or more data providers 102 can store source data, associated data, or both. A user-interface component 114 can obtain data from the data-provider interface component 112 for display to a user. In an illustrative embodiment, the user-interface component 114 represents the front-end of a stand-alone application. Alternatively, an application-interface component 110 can integrate the user-interface component 114 with one or more software applications 116. For example, the user-interface component 114 can be integrated into a software development application such that authors have access to validated resources and localized information in the typical development environment. The user-interface component can be integrated with any type of authoring program, such as, for example, a content authoring program. In the case of content authoring, instead of reusing available resources, available content would be re-used. Content authoring is discussed in more detail below.

One skilled in the relevant art will appreciate that the data and/or components may be stored on a computer-readable medium and loaded into memory of the client device 108 using a drive mechanism associated with the computer-readable medium, such as a floppy, CD-ROM, DVD-ROM drive, or network interface. Further, the components can be included on a single device or distributed in any manner. For example, all the components could be located on the client device 108. Furthermore, the components can be integrated in any manner. For example, the user-interface component 114, data-provider interface component 112, and application interface component 110 could be integrated into a single component. Furthermore, the components shown in FIG. 1 represent an illustrative embodiment. In other embodiments, components can be removed or their functionality can be provided by another component. For example, the data manager component 104 and data-provider interface component 112 may be removed or their functionality could be provided by another component.

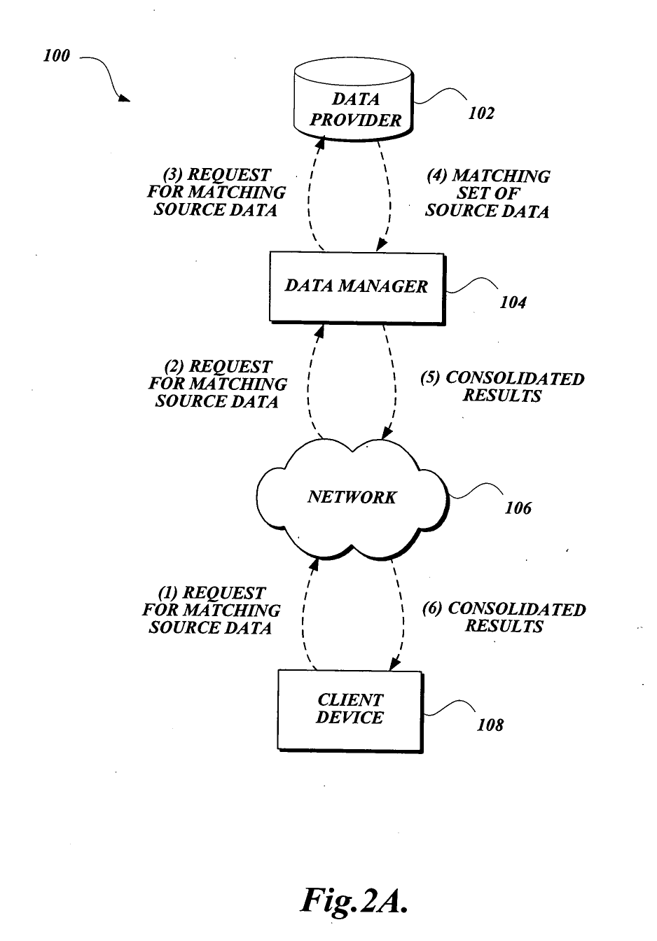

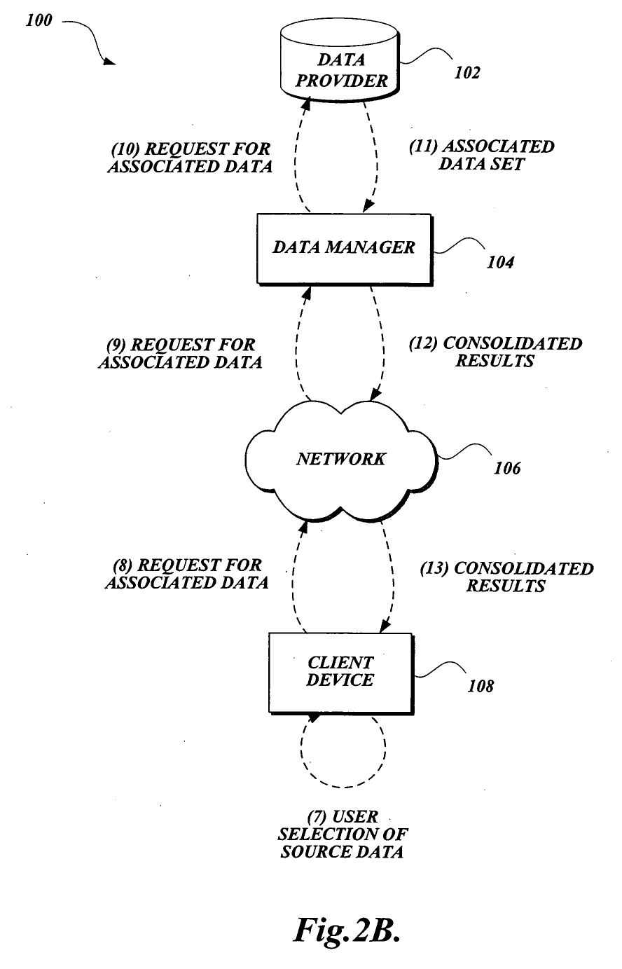

With reference now to FIG. 2A, the interaction by various components of the operating environment 100 to provide a consolidated set of source data to a client device 108 will be described. As illustrated in FIG. 2A, a client device 108 issues a request for source data matching the source string. The request can be issued in response to user interaction with the client device 108. The request for matching source data can be transmitted via a communications network 106, such as the Internet. A data manager 104 obtains the request and issues queries to one or more data providers 102 for matching source data. Various types of queries can be executed against the data providers 102. For example, the data providers 102 can provide exact matches to the source string. Further, the data providers 102 can provide approximate matches, such that source data with related terms are provided. Still further, partial matches can be provided. Regular-expression matching, including the use of wildcards, can also be provided. Additionally, matches can be provided against a range of values. Further, matches against transformations can be provided. For example, if a user desires to perform a transformation search against the word “copy”, a query for “copy” in any morphological form would be conducted. Thus, matches including the words “copied” and “copies” would be returned. Furthermore, each type of search can be combined with one or more other types of searches. The searches can also be run against source data, associated data and/or metadata corresponding to the source data or associated data. It will be appreciated by one skilled in the art that the technique(s) for matching the source string to a set of source data is not limiting.

With continued reference to FIG. 2A, the data manager 104 can obtain a set of matching source data from the one or more data providers 102. In an illustrative embodiment, each set of source data can include elements which correspond to resources. Each resource may have been previously validated. For example, each resource may have been through a functional validation process, a linguistic validation process, a process of validating against a black-list or white-list, a stylistic validation process, a process for ensuring consistent terminology across source and target data, a process for validating that the data is consistent, as well as other validation processes. Validating against a black-list involves checking for terminology that should not be included in the data while validating against a white-list involves checking for terminology which should be included in the data. A special case of black-list validation involves checking the data for geopolitical issues. The various types of validation will be described in more detail below. In practice, each resource can correspond to a string which was previously used in the user interface of another application. Furthermore, each resource can include corresponding metadata. The metadata can be used to validate the resource or provide additional information about the resource. With continued reference to FIG. 2A, the data manager 104 consolidates the one or more data sets into one consolidated result set. By consolidating the one or more data sets, the data manager 104 can remove redundant elements from the consolidated result set and prioritize data within the consolidated result set. The consolidated source data can be transmitted via a communications network 106 to client device 108. Although the data manager 104 can provide an initial ranking of data according to priority, the priority of data can change after the consolidated results are transmitted. For example, a user on the client device can re-order the data. In an illustrative embodiment, the data manager 104 can be included as a component on the client device 108. Further, the one or more data providers 102 can be components on the client device 108 or local to the client device 108.

With reference now to FIG. 2B, the interaction by various components of the operating environment 100 to provide a consolidated set of associated data to a client device 108 will be described. Associated data can be requested by a user after a user views the set of source data. For example, the associated data could be a set of translations which correspond to a user selection of source data. As illustrated in FIG. 2B, a user makes a selection from the source data. A client device 108 issues a request for associated data corresponding to a user selection of source data. The request for associated data can be transmitted via a communications network 106, such as the Internet. A data manager 104 can obtain the request and can issue queries to one or more data providers 102 for associated data.

With continued reference to FIG. 2B, the data manager 104 can obtain a set of associated data from the one or more data providers 102. In an illustrative embodiment, each set of associated data can include elements which correspond to translations in various languages of the user selection of source data. Further, the data providers 102 can provide pseudo-translations which can be used for testing purposes. Each element of an associated data set can be valid and verified. In practice, each element corresponds to a valid and verified translation of the user selection of source data. Furthermore, each associated data set element can include corresponding metadata. The metadata can be used to validate the element or provide additional information about the element. With continued reference to FIG. 2B, the data manager 104 consolidates the one or more associated data sets retrieved from the one or more data providers 102 into one consolidated result set. By consolidating the one or more associated data sets, the data manager 104 can provide a consolidated set of associated data which is prioritized and free of redundant elements. The consolidated associated data set can be transmitted via communications network 106 to client device 108. Client device 108 can display the associated data set and/or persist the associated data set to a file. In an illustrative embodiment, the associated data set can be obtained with the source data such that a separate query for the associated data set is unnecessary. Although FIG. 2B depicts the transmission of a request for associated data to a data provider 102, it will be appreciated that the associated data could be obtained from a data provider 102 along with the consolidated results. In such a case, the associated data could then be stored on the client device 108 until requested by a user.

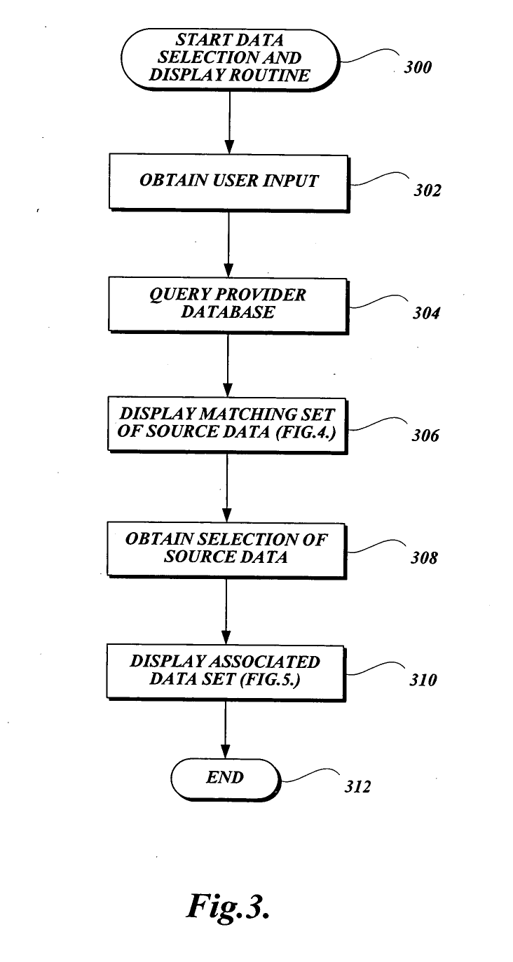

With reference now to FIG. 3, a flow diagram illustrative of a data selection and display routine implemented by a client device 108 will be described. At block 302, user input is obtained. For example, the user-interface component 114 can obtain user input in the form of a source string from a user. As will be explained further below, the source string can be validated using metadata. In practice, the source string can be validated as the user types it in to alert the user of any possible issues. At block 304, the source string is used to create a query for matching source data from the one or more data providers 102. For example, the source string can be used by the client device 108 to create a request for matching source data. The request is forwarded to the data providers 102. In an illustrative embodiment, the request is forwarded to a data manager component 104 which queries the data providers 104 for source data. Matching source data is provided to the client device 108. The data provider queries can perform approximate matching, exact matching, partial matching, regular expression matching, or other types of searches well-known in the art. Furthermore, regular expression matching can include wildcards. At block 306, a matching set of source data is provided to the client device 108 and displayed. In an illustrative embodiment, the data manager 104 consolidates the source data before it is provided to the client device 108.

With continued reference to FIG. 3, at block 308, the client device 108 obtains a user selection of source data. For example, the source data can include one or more validated resources that correspond to the source string. In practice, a user can select the resource that meets the requirements of an application being developed by the user. The client device 108 can forward a request for associated data corresponding to the user selection of source data to the one or more data providers 102. Alternatively, the associated data may have been returned with the source data and can be retrieved from the memory of the client. In an illustrative embodiment, a data manager component 104 obtains the request for corresponding associated data and queries one or more data providers 102. The data manager 104 can consolidate the associated data sets received from the one or more data providers 102 into a consolidated associated data set. For example, the data manager 104 can remove redundant elements from the consolidated associated data set. At block 310, the associated data set is obtained by client device 108 and displayed to a user. Alternatively, or additionally, the associated data set can be persisted. In an illustrative embodiment, the associated data set includes one or more translations corresponding to the user selection of source data. The translations can be validated and verified. Further, the user can select one or more translations for use in an application. At block 312, the data selection and display routine 300 ends.

The data provider queries can also include queries across data types. For example, a user can search for a source string which matches an audio file, another string, a bitmap, a video file, or any other date type. Furthermore, searches can be further restricted using metadata which specifies attributes of corresponding source data and associated data. For example, metadata can specify the author of the data, the language, the size of the corresponding data, in what context the data was previously used (e.g., on a button, in a script, etc.), or other attributes. If the corresponding data is a bitmap, the metadata can specify the color depth of the bitmap. Utilizing the metadata, the data queries can be restricted such that only data from a specific author or of a specific size is returned. For example, if an author creates a string for use as a button label, when running the search, the author can specify that only data which was previously used as a button label should be returned.

With reference now to FIG. 4, an illustrative user interface 400 provided by client device 108 for displaying a source string 404 and source data 412 will be described. A source string display portion 406 can be used to display the source string 404. The source string can be obtained from a user through an input device. For example, the user can type the source string 404 directly into the source string display portion 406. Alternatively, a user can copy and paste the source string from another application or retrieve the source from the memory of the client device 108. Other techniques well-known in the art can be used to obtain the source string 404. A source string display control 402 can be used to hide or display the source string display portion 406. Furthermore, the user can choose the language the source string should be entered in and the language or languages of source data and associated data.

The source string 404 can be validated. In an illustrative embodiment, the source string is validated as the user types it into the source string display portion 406. Different types of validation can be performed on the source string 404. For example, a functional validation can be performed to detect localizability issues. Further, functional validation can be used to verify that portions of a source string which have functional aspects will continue to function correctly in a target string. For example, variables within a source string, sometimes referred to as “placeholders”, are replaced with a value before the string is displayed to a user. Functional validation can be used to verify that placeholders will continue to function correctly in localized versions of the source string. In an illustrative embodiment, functional validation can be directly integrated into the software development environment. For example, functional validation can be directly integrated such that validation can be performed while the author is entering source text. This allows the author to be notified immediately of any potential issues. Because validation can be performed during development of an application, an author or developer can decide whether to change the source string to be consistent with constraints imposed by the application or whether to modify any constraints imposed by the application such that the source string validates against those constraints. Performing validation at design time allows the designer to modify the application when it is most efficient to do so.

A linguistic validation can also be provided to help users create source strings that are free of grammar and spelling errors. Linguistic validation can also be performed as the source string is input by a user. White-list and black-list validation can be performed against terms in a string. As discussed above, a white-list validation validates that terms on a white list appear in the string whereas a black-list validation validates that terms on a black list do not appear in the string. Geopolitical validation is a type of terminology validation and can be performed against a black-list or white-list to verify that a source string conforms to geopolitical requirements. For example, country A may not recognize the existence of country B. As such, using the name of country B in products targeted to country A the can cause the product to be ill-received. Geopolitical validation can verify that source strings do not contain such geopolitically sensitive terms. Likewise, geopolitical validation can be used to verify that products shipped to country B include country B's name where appropriate. Geopolitical validation can be performed as the source string is input by a user. Geopolitical validation can also be performed on target strings. As demonstrated by geopolitical validation, the validation techniques used are market-dependent. That is, the validation techniques used can change based on the target market. A stylistic validation can verify that the source string 404 is understandable to humans and/or machine translation engines. Stylistic validation can be performed as the source string is input by a user. The different types of validation can be provided within a stand-alone tool or integrated into other applications.

With continued reference to FIG. 4, certain portions of a source string 404 can be marked. For example, a portion of the source string can be flagged by the validation techniques described above and can be marked so that a user can locate validation issues. For example, a variable within a source string can have functional aspects and can thus be marked. Furthermore, phrases or words, such as “file” can have a certain meaning which needs to remain consistent across localizations of the source string and. These special words or phrases can also be marked. Portions of the source string can be marked in any manner. For example, source string portions can be underlined, bolded, italicized, highlighted, appear in a different size font, or marked in any other manner well-known in the art. Further, any portion of the source string 404 can be marked, including the entire string.

Illustrative user interface 400 can also include a status display control 408 for hiding or displaying a status display portion. The status display portion can be used to provide status information. Search display control 410 can be used to display or hide a source data display portion 412. The source data display portion 412 can display source data corresponding to the source string 404. The source data can be retrieved by a user by clicking button 426. In an illustrative embodiment, the source data is retrieved from one or more data providers 102. The source data can include available resources. Alternatively, the source data can include available content. The source data can also include tags which link to resources or content which have not yet been finalized. For example, an author may create a new resource or content and make the item available. Other authors can choose to link to the tag even though it has not been finalized or validated. Once the resource or content is finalized, the link allows the finalized version to be obtained automatically. In an illustrative embodiment, the source data includes user-interface strings which have been previously used in other applications. Consistency within an application and across applications can be achieved by re-using existing strings. A key term or terms can be entered into the source string display portion 406 and used to form the query for source data 412. The user can also attempt to type the string exactly as they would like it to appear. Metadata corresponding to the resources in the source data 412 can also be retrieved from the one or more data providers 102, either simultaneously or any time at the user's request. The metadata can provide information about the resources and be used to validate the resources. User-interface 400 can also include an indicator 416 of the number of resources included in the source data set. Metadata display control 418 can hide or display a metadata display portion. The metadata display portion will be described below. An MT (machine translation) check display control 424 can hide or display an MT check display portion. Running a machine-translation check provides the user with an indicator of the quality of a potential machine translation of the source string. Copy button 428 can be used to copy source strings or source data to other portions of the display or to other applications.

With reference now to FIG. 5, a block diagram depicting the illustrative user interface 400 of FIG. 4 including a display portion 500 for displaying data associated with a user selection 414 of source data will be described. After reviewing the list of resources in the source data display portion 412, the user can select a resource to retrieve an associated data set 500. For example, the user can select the resource “The spooler file was not found.” 414. In an illustrative embodiment, the selected resource 432 also appears in the source string display portion 406. To retrieve a set of data associated with the selected resource 414, the user can click button 426. In response, client device 108 can forward a query to the one or more data providers 102 in order to retrieve the associated data set 500. The data providers 102 that provide source data 412 can be distinct from the data providers 102 which provide the associated data. Once the associated data set is obtained by the client device 108, it can be displayed in a display portion 500 by, for example, user-interface component 114. Copy button 428 can be used to copy selected elements from the associated data set to other portions of the display or to other applications.

Each time an available resource or content is selected, the selected item can include a link back to the element of source data such that if the element is modified at a later date, the modification can be obtained automatically. For example, a user may select a resource such as “File not found in root directory”. At a later time, the resource may be modified to “File not found in base directory”. Because of the linking, all users who have selected this item can automatically retrieve the updated item. In this way, terminology consistency across applications can be provided. Likewise, links can be provided for elements within the associated data. As discussed above, the associated data can include localized information corresponding to the selected element of source data. If the localization changes, the modified localization can be obtained automatically due to the provided linking. Furthermore, any new localization can be automatically retrieved as a result of the provided linking. Thus, the present invention provides for consistent source and associated data across applications. Furthermore, the validation techniques can provide for centralized validation of the source and associated data.

In an illustrative embodiment, the associated data set can include one or more localized versions of the selected source data 414. For example, the associated data set can include one or more translations. In an illustrative embodiment, the associated data set can include a mapping of the selected source data 414 into a sound with equivalent meaning in the same language or another language. Other types of localized information well-known in the art can also be provided. The other types of localized information are sometimes referred to as equivalent re-interpretations. The associated data can be validated and verified that it was localized correctly. Further, the associated data could have been used previously in another application. Thus, by choosing to use a localization included in the associated data set corresponding to the selected source data, a user can ensure consistency both within an application and across applications. The associated data set display portion 500 can include a language column 502 to provide an indication of the language corresponding to a translation and a text column 504 for displaying localized versions of the selected source data. The user can select one or more of the localizations to include in a localized application. The source string 404 and source data 412 can be in any language. Thus, not only can translations from English to another language be provided, but translations from any language into any other language can be provided. Furthermore, by seeing which localizations are available for a particular element of source data, the user can choose to use an element of source data which has corresponding localizations which the user will eventually need.

Metadata 430 can also be obtained from the user. Metadata can include a name-value pair 420. Further metadata can be used to validate a resource, source string, or associated data. For example, a user can place a maximum length constraint on a string using metadata. If the user desires to constrain a string to a maximum length of 40, the user can select or enter “MaxLength” as the name of the constraint and enter “40” into the value column. The “MaxLength=40” constraint 422 can be used to verify that the source string 432 does not exceed a length of 40. Metadata entered by a user can be used in addition to or in lieu of the validation techniques discussed above. The capturing of metadata can be integrated into the software development environment. Terminology metadata can also be entered by a user. For example, terms in a source string can be ambiguous. Terminology metadata entered by a user can clarify the ambiguity. Terminology metadata can be used by localizers to produce accurate localizations.

Although illustrative embodiments have been generally discussed in the context of developing applications, it will be appreciated by one skilled in the art that the embodiments discussed herein are extensible to include content-authoring environments. For example, content authors could utilize the embodiments discussed herein to ensure that content is consistent across various platforms. Web page authors could utilize linking to ensure that the look and feel of Web pages is consistent across a Web site. Likewise, document authors could utilize linking to create document templates which ensure that standard content within a document is consistent. Furthermore, by linking content, not only is consistency assured in the source data, but valid, verified, and consistent localizations can also be efficiently made available. For example, once linked content in language A is translated into language B, the translation will be available to all the linkers of the content in language A.

Although illustrative embodiments have been generally discussed in the context of a user interface, it will be appreciated by one skilled in the art that the embodiments discussed herein are extensible to include a batch processing system. For example, a batch processing system with batch processing components can process several source strings at once. The source strings can be read from data storage, with corresponding source data, associated data, and any errors persisted to storage. In this manner, several source strings could be processed with the results persisted to data storage.

While illustrative embodiments have been illustrated and described, it will be appreciated that various changes can be made therein without departing from the spirit and scope of the invention.

The embodiments of the invention in which an exclusive property or privilege is claimed are defined as follows:

1. A method for processing data comprising:
obtaining a request for available source data corresponding to a source string in any language; and
in response to the request, providing a consolidated set of available source data and corresponding linking data, wherein the linking data links elements within the consolidated set such that updates to any one element propagate to all selections of the element.

2. The method as recited in claim 1, further comprising:
obtaining a request for available associated data corresponding to a user selection of source data; and
in response to the request, providing a consolidated set of available associated data, wherein the consolidated set of available associated data includes localized information corresponding to the user selection of source data.

3. The method as recited in claim 1, further comprising:
submitting a query for available source data matching the source string to each of a plurality of data providers;
obtaining a set of matching available source data from at least one of the plurality of data providers; and
consolidating each set of matching available source data into a single set of available source data, wherein consolidation of the source data involves prioritizing the order of elements within the consolidated set of available source data.

4. The method as recited in claim 2, further comprising:
submitting a query for available associated data corresponding to the user selection of source data to each of a plurality of data providers;
obtaining a set of available associated data from at least one of the plurality of data providers; and
consolidating each set of available associated data into a single set of available associated data, wherein consolidation of the associated data involves prioritizing the order of elements within the consolidated set of available associated data.

5. The method as recited in claim 1 further comprising:
providing metadata corresponding to the available source data, wherein the source data can include one or more resources, and wherein metadata can be used to validate the one or more resources.

6. The method as recited in claim 2 further comprising:
providing metadata corresponding to the set of available associated data, wherein the metadata can be used to validate the localized information included in the associated data set.

7. The method as recited in claim 2, wherein the localized information includes one or more elements, and wherein each element corresponds to at least one of: (1) a translation of the user selection of source data and (2) an equivalent re-interpretation of the user selection of source data.

8. The method as recited in claim 1, wherein the request for available source data retrieves data that matches the source string according to at least one of: (1) an approximate matching, (2) a regular expression matching, (3) an exact matching, (4) a range matching, and (5) a transformation matching.

9. In a computer system including a display and an input device, a method for displaying data corresponding to a source string, the method comprising:
obtaining a set of available resources corresponding to the source string;
displaying the set of available resources;
obtaining a selection of an available resource;
obtaining an associated data set, wherein each element in the associated data set corresponds to a localized version of the selected resource; and
displaying or persisting the associated data set.

10. The method as recited in claim 9 further comprising:
obtaining metadata from an author of the source string; and
at design time, validating the source string and any corresponding localizations using the metadata.

11. The method as recited in claim 10, wherein at least a portion of the metadata corresponds to information about meaning of terms in the source string.

12. The method as recited in claim 9 further comprising:
obtaining the source string from a user through the input device; and
validating the source string.

13. The method as recited in claim 12, wherein validating the source string includes performing a stylistic validation to determine whether the source string is understandable.

14. The method as recited in claim 12, wherein validating the source string includes performing a functional validation to determine whether the source string conforms to requirements of a selected environment.

15. The method as recited in claim 12, wherein validating the source string includes performing a terminology validation to ensure that the source string includes only valid terms.

16. The method as recited in claim 12, wherein validating the source string includes performing a linguistic validation to determine whether the source string conforms to grammar and spelling rules.

17. A computer-readable medium having computer-executable components for processing data comprising:
a data-processing component for obtaining a source string and available source data, wherein the source data includes one or more validated resources corresponding to the source string; and
a data-provider interface component for transmitting a request for associated data corresponding to a selection of source data and for obtaining the associated data; wherein the associated data includes localized information corresponding to the user selection of source data.

18. The computer-readable medium as recited in claim 17 further comprising:
a data manager component for consolidating data sets received from one or more data provider components and for distributing the consolidated data to the data-provider interface component.

19. The computer-executable components of claim 17, wherein a user interface component displays the associated data obtained by the data-provider interface component.

20. The computer-readable medium as recited in claim 17, wherein the associated data is persisted into a file.
